(19) United States
(12) Patent Application Publication
(10) Pub. No.: US 2011/0308524 A1
(43) Pub. Date: Dec. 22, 2011

(54) COMPACT MULTIGAS FILTER

(76) Inventors: Larry A. Brey, Woodbury, MN (US); Duane D. Fansler, Dresser, WI (US); Lisa M. Croll, Battersea (CA); Simon J. Smith, Glenburnie (CA)

(21) Appl. No.: 13/139,636

(22) PCT Filed: Dec. 3, 2009
(86) PCT No.: PCT/US09/66500

§ 371 Date: Sep. 1, 2011

Related U.S. Application Data
(60) Provisional application No. 61/139,700, filed on Dec. 22, 2008.

(51) Int. Cl. A62B 7/10; B01D 53/02

(52) U.S. Cl. 128/205.12; 96/134; 422/122

(57) ABSTRACT

A filter assembly includes a filter bed comprising at least one chemical filtering medium and a pleated filter element. The pleated filter element includes a particulate filtering medium and at least one chemical filtering medium. In one implementation, the pleated element includes a non-woven web of polymeric fibers and more than 60 percent weight sorbent particles enmeshed in the web. At least one chemical filtering medium in the pleated element and at least one chemical filtering medium of the filter bed can be designed to be capable of targeting different chemical substances. Some filter assemblies of the present disclosure may be disposed within an interior of a fluid-impermeable housing having an inlet and an outlet.

### FIELD OF THE DISCLOSURE

The present disclosure pertains to filter assemblies including both chemical and particulate filtering media. More particularly, the present disclosure pertains to filter assemblies including a filter bed and a pleated filter element.

### BACKGROUND

Current trends in industrial, military and first responder respiratory protection indicate an increasing need for compact filters that target a variety of particulate and gaseous toxic materials. In an attempt to meet this need, various filters have been designed.

One known filter design comprises a traditional granular bed with a single layer or with multiple layers. Such filters with multiple granular bed layers are typically capable of removing multiple types of gases. Other filter configurations include co-pleated particulate and chemical filtering media. Although such configurations are effective under certain circumstances, there still exists a need for a filter technology that even more effectively targets various particulate contaminants and gases and is compact and has a low pressure drop and high breakthrough time.

### SUMMARY

The present disclosure provides, in one aspect, a filter assembly comprising a filter bed comprising at least one chemical filtering medium, and a pleated filter element comprising a particulate filtering medium and at least one chemical filtering medium. In this exemplary embodiment, at least one chemical filtering medium of the pleated filter element and at least one chemical filter medium of the filter bed are capable of targeting different chemical substances.

In another aspect, the present disclosure provides a filter assembly comprising a substantially fluid-impermeable housing having an interior, an inlet and an outlet in fluid communication with the inlet. The filter assembly also includes a filter bed comprising a chemical filtering medium disposed within the interior of the housing, and a pleated filter element. The pleated filter element is disposed within the interior of the housing, and comprises a particulate filtering medium and a chemical filtering medium.

In another aspect, a filter assembly comprises a filter bed including a chemical filtering medium and a pleated filter element. The pleated element comprises a non-woven web of polymeric fibers and more than 60 percent weight sorbent particles enmeshed in the web.

In yet another aspect, a respiratory protection device includes a face piece that generally encloses at least the nose and mouth of a wearer and a filter assembly according to an exemplary embodiment of the present disclosure connected to the face piece. An air intake path for supplying ambient air to an interior portion of the face piece passes through the filter assembly.

### BRIEF DESCRIPTION OF THE DRAWINGS

The invention may be more completely understood in consideration of the following detailed description of various embodiments of the invention in connection with the accompanying drawings, in which:

FIG. 1 shows schematically a cross-sectional view representing a planar filter assembly according to an embodiment of the present disclosure.

FIG. 2 shows schematically a cross-sectional view of an exemplary pleated element according to the present disclosure.

FIG. 3 shows an exemplary filter assembly in a planar configuration according to an embodiment of the present disclosure.

FIG. 4 shows an exemplary filter assembly in a cylindrical configuration according to an embodiment of the present disclosure.

FIG. 5 shows an exemplary respiratory protection device including an exemplary filter assembly according to the present disclosure.

FIG. 6 is a chart showing break through times for different embodiments of the current disclosure under ammonia removal testing according to the National Institute for Occupational Safety and Health (NIOSH) CBRN APER (2003) standard.

FIG. 7 is a chart showing pressure drop and break through time for different embodiments of the current disclosure under ammonia removal testing according to the NIOSH CBRN APR (2003) standard.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Some exemplary embodiments of the present disclosure include a filter assembly including a filter bed and a pleated filter element including particulate and chemical filtering media, wherein the chemical filtering medium in the pleated element and the filter bed are capable of targeting different substances. Such embodiments can be particularly useful in instances where the substance desired to be filtered is unknown in advance, and can allow the filter assembly to target multiple potential substances to provide a wide spectrum of protection. The combined use of a pleated chemical element and filter bed to target multiple substances offers a wide spectrum of protection while maintaining a smaller volume, relatively low pressure drop and comparatively high breakthrough time. Suitable potential applications for the present disclosure may include military, first responder, and industrial respiratory protection systems.

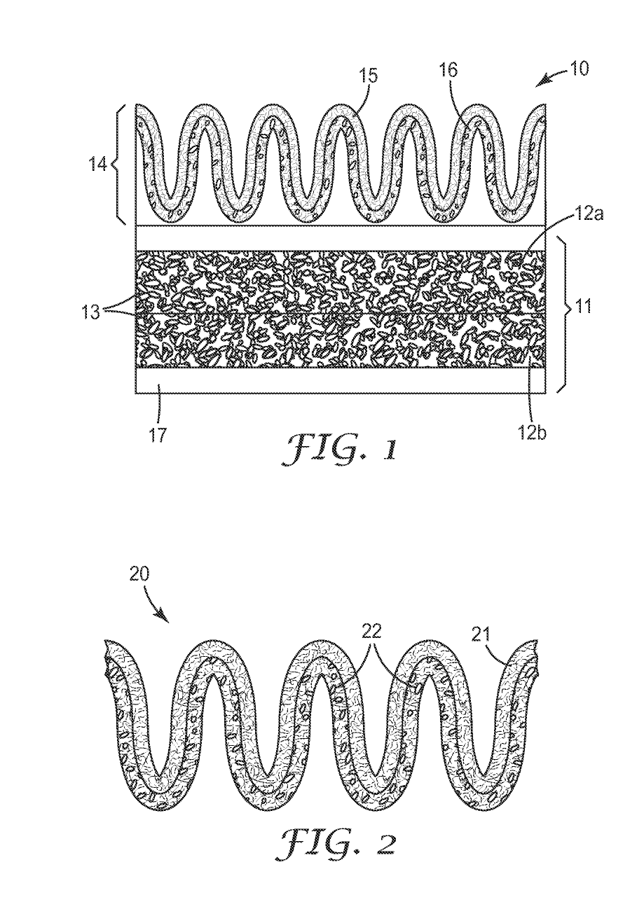

A cross-sectional view of an exemplary filter assembly 10 is illustrated in FIG. 1. In this embodiment, the filter system 10 includes a filter bed 11, which in turn includes a chemical filtering medium 13. The chemical filtering medium 13 may include one or more of a sorbent, a catalyst or a chemically reactive medium. In some exemplary embodiments, a sorbent and/or catalyst may be at least partially deployed in the form of particles. For example, the particles can be in the form of pellets, beads, or granular adsorbent material.

The mesh size for sorbent particles can be about 20×40 where ‘20’ refers to a mesh density through which substantially all of the particles would fall through and ‘40’ refers to a mesh density that is sufficiently high so as to retain substantially all of the particles. For example, a mesh size of 20×40 means that substantially all of the particles would fall through a mesh having a mesh density of 20 wires per inch and substantially all of the particles would be retained by a mesh having a density of 40 wires per inch. Selecting an appropriate mesh size requires balancing density and filter capacity against air flow resistance. Generally a finer mesh size provides greater density and filter capacity, but also higher airflow resistance. Balancing these concerns, specific examples of mesh sizes found to be suitable in the present disclosure include, but are not limited to, 12×20, 12×30, 12×40 and 20×40.

The filter bed 11 may include sorbent particles including any one or more of activated carbon, alumina, zeolite, silica, and the like. Specific examples of particles that can be used in the present disclosure include: zinc chloride (ZnCl₂) treated carbon which removes ammonia (NH₃) and organic vapors (OVs) and an exemplary activated carbon, impregnated with copper, silver, zinc, molybdenum, and triethlyenediamine (TEDA). Suitable particles also include activated carbons, such as multigas activated carbons including one or more of copper, zinc, molybdenum, sulfuric acid and a salt thereof, such as carbons available form Calgon Carbon Corporation, and particularly, an activated carbon type such as Universal Respirator Carbon (URC), which includes copper and zinc in a total amount of not more than 20%, molybdenum compounds of up to 10%, sulfuric acid or a salt thereof of up to 10%, and can remove acid gases (such as SO₂, H₂S ), basic gases (such as NH₃), hydrogen cyanide and organic vapors (such as CCl₄, toluene, most hydrocarbons). Other exemplary particles include a zinc acetate and potassium carbonate treated carbon material as described in U.S. Pat. No. 5,344,626, which can remove acid gases, hydrogen cyanide and organic vapors; or an untreated carbon such as a coconut based, acid washed carbon without additional chemistries which can remove organic vapors.

The filter bed 11 may include catalysts and/or supported catalysts instead of or in addition to sorbent particles. A catalyst facilitates a reaction with the targeted chemical or chemicals when it passes through the filter bed 11 to convert it into a nontoxic or well-retained species. For example, the filter bed may include catalyst materials such as a combination of copper oxide and manganese dioxide (e.g., catalyst type Carulite 300 from MSDS) which removes carbon monoxide (CO), hydrogen cyanide (HCN), some acid gases (such as SO₂) and some basic gases (such as NH₃) or catalyst containing nano sized gold particles, and a granular activated carbon coated with titanium dioxide and with nano sized gold particles disposed on the titanium dioxide layer, (United States Patent Application No. 2004/0095189 A1) which removes CO, OV and other compounds.

In the particular exemplary embodiment illustrated in FIG. 1, the filter bed 11 includes two filter bed layers 12. Alternatively, the filter bed 11 may have 3, 4 or more filter bed layers or it may have only one layer. In an embodiment where there is more than one filter bed layer, filter bed layers 12 may include materials with similar or different filtering properties. For example, any number of the materials discussed above may be used in a filter bed layer 12.

In an exemplary embodiment, one filter bed layer may contain a granular activated carbon treated with triethylenediamine (TEDA), preferably, 2-5% TEDA (e.g., activated carbon type Pica Nacar B from Pica USA, Inc.), a second filter bed layer may contain an activated carbon including one or more of copper, zinc, molybdenum, sulfuric acid and a salt thereof (e.g., URC, containing copper and zinc in a total amount of not more than 20%, molybdenum compounds of up to 10%, sulfuric acid or a salt thereof of up to 10%). Considerations for determining the disposition of filter bed layers 12a, 12b include, for example, whether a filter bed layer 12b must be protected from an incoming gas, in which case it can be placed downstream in relation to another bed layer 12a, and/or typically a bed layer 12b targeting a gas that is particularly difficult to remove is placed downstream. Filter beds can include packed sorbent particles and can be made with methods known to individuals skilled in the art. For example, a filter bed could be made by a method of snowstorm filling as described in U.S. Pat. No. 6,344,071 or UK Patent No. 606,867. Filter bed 11 could also be a granular carbon bed which is held in place by a standard method of compression and stake welding of plastic retainers. A filter bed 11 could also contain one or more layers of supported sorbent particles as described in United States Patent Application No. 2006/0096911 and/or one or more bonded sorbent particles as described by U.S. Pat. No. 5078132. A filter bed 11 may additionally include any other appropriate structural components including, but not limited to, containing bodies, retaining plates, liners, compression pads, scrims and the like.

Referring further to FIG. 1, the filter assembly 10 also includes a pleated filter element 14. The exemplary pleated filter element 14 includes both a particulate filtering medium 15 and a chemical filtering medium 16. The particulate filtering medium 15 may be composed of a textile material, such as a non-woven web, preferably derived from either a melt blowing or a needle felting process, or alternately, a membrane can be applied.

In a preferred embodiment, the filtering medium provides high efficiency particle capture through the sub-micron range, sufficient to meet classifications defined in regulatory standards. An example is the P100 classification of 42 CFR 84 applicable to respiratory devices intended for sales in North America. Under European standards an analogous level of performance is designated as P3. To achieve the required level of capture performance at low enough pressure drop, a melt-blown non-woven material from the group of surface modified electrets may be applied. These are meltblown materials that have been processed in a way to tailor their performance towards filtration applications. Processing post-extrusion applies an elevated level of electric charge, along with surface modification to apply fluorochemistry to the fiber surfaces. If a needle-felt is applied, it should also be an electret modified version incorporating fluorochemistry treatment. If a high-efficiency membrane is applied these treatments are not necessary, however, the membrane needs to deliver the required collection efficiency at low enough airflow resistance. An example of a suitable membrane is a polytetrafluoroethylene (PTFE) membrane. In general, the non woven media should meet the collection efficiency need while contributing a resistance of less than about 180 Pa. at an airflow of 5.2 cm/sec.

In the illustrated exemplary embodiment, the particulate filtering medium 15 and the chemical filtering medium 16 are deployed in the form of layers, with the particulate filtering medium 15 located upstream of the chemical filtering medium 16. Alternatively, the chemical filtering medium 16 may be located upstream of the particulate filtering medium 15. Additionally, there may be more than one layer of particulate filtering medium 15, chemical filtering medium 16 or both. In other exemplary embodiments, the particulate filtering medium 15 and the chemical filtering medium 16 may be combined, such that they would not form well defined layers, or any layers. For example, the chemical filter medium 16 may be in the form of active particles interspersed throughout the particulate filtering medium.

In a typical embodiment of the present disclosure, the chemical filtering medium 16 possesses filtration properties that differ from at least one filter bed layer 12. The chemical filtering medium 16 has the capability to target a different chemical or a different set of chemicals than at least one filter bed layer 12. This allows the chemical filtering medium 16 and the filter bed layer 12 to work in concert. For example, some filters may rely on a carbon bed including activated impregnated carbons, such as carbons impregnated with one or more of copper, silver, zinc, molybdenum and TEDA. One example of such activated impregnated carbons is ASZM-TEDA type carbon from Calgon Carbon Corporation (suitable activated carbons are also described in U.S. Pat. No. 5,063,196). Although the exemplary ASZM-TEDA carbon may remove many classes of compounds such as acid gases, cyano-gases and organic vapors, it does not substantially remove basic gases, such as ammonia. To overcome this potential limitation, a pleated chemical filtering material, containing an ammonia-specific sorbent such as ZnCl₂ can be added to the inlet side of the filter assembly. This can significantly increase the ammonia removal capability of the filter without significantly increasing the size and weight of the filter assembly.

In another embodiment consistent with the present disclosure, the chemical filtering medium 16 possesses filtration properties that are similar to the filtration properties of at least one filter bed layer 12. This may be desirable when constructing a filter that would comply with the current NIOSH CBRN standards for operational and escape type filters. NIOSH CBRN standards require that an approved filter removes biological and other particulates, as well as a list of 10 gases selected to represent families of toxic compounds. The 10 gases are sulfur dioxide (SO₂), hydrogen sulfide (H₂S), formaldehyde (H₂CO), ammonia (NH₃), hydrogen cyanide (HCN), cyanogen chloride (ClCN), phosgene (COCl₂), cyclohexane (C₆H₁₂), nitrogen dioxide (NO₂) and phosphine (PH₃). Typically, filters meeting these types of standards have been constructed using a carbon capable of removing all such gases, or by using layers of carbons that collectively remove all of the listed classes of compounds. In both cases one gas from the above set of 10 drives the need for increased amounts of granular sorbent material. In the case of current carbon technologies, this gas is often ammonia. In this case, in accordance with the present disclosure a pleated chemical filtering material, containing an ammonia-specific sorbent, such as ZnCl₂, can be added to the inlet side of the filter can increase the ammonia breakthrough time from 7 to 30 minutes while maintaining a compact size.

In another embodiment of the present disclosure, the chemical filtering medium 16 possesses chemical removal capabilities similar to the removal capabilities of one or more of the carbons in the packed bed. For example, with the addition of a pleated chemical filtering material containing a multigas activated carbon, such as URC, the ammonia and sulfur dioxide breakthrough times may be increased from 1 to 14 minutes and from 6 to 21 minutes respectively.

In some embodiments, the particulate filtering medium 15 and chemical filtering medium 16 can be provided as individual sheets and held together with netting (such as thermoplastic netting) in the filter assembly 10. In a preferred embodiment the netting is a bi-planar polypropylene extruded netting. Examples of suitable bi-planar polypropylene extruded netting are commercial products, such as a product bearing the trade name Vexar grades L190 or L185 products offered by MasterNet Company, or other suitable products. Alternatively, the particulate filtering medium 15 and chemical filtering medium 16, along with a stiffening layer, can be laminated and pleated as a single unit to form the pleated filter element 14. A swirl type glue lamination process or laminating webs can be applied to join the three layers.

FIG. 2 illustrates schematically an exemplary chemical filtering medium suitable for use in pleated elements of the present disclosure. In this exemplary embodiment, the chemical filtering medium includes a non-woven web 20 of polymeric fibers 21. The non-woven web can be a fibrous web characterized by entanglement or point bonding of the fibers. For example the web can be formed by extruding a fiber-forming material through multiple orifices to form filaments while contacting the filaments with air or other attenuating fluid to attenuate the filaments into fibers and thereafter collecting a layer of attenuated fibers 21. The web 20 is porous so that it is permeable to fluids and gases. In one embodiment, more than 60 percent weight sorbent particles 22 are enmeshed in a non-woven web 20, for example, by using a melt-blowing process described by United States Published Application No. 2006/0096911 A1, incorporated here by reference. In other exemplary embodiments, 80 percent weight or more sorbent particles 22 may be enmeshed in the non-woven web 20. The enmeshed particles 22 can be sufficiently bonded to or entrapped within the web so as to remain within or on the web when the web is subjected to gentle handling.

The fibers 21 may include a thermoplastic elastomeric polyolefin, a thermoplastic polyurethane elastomer, a thermoplastic polybutylene elastomer, a thermoplastic polyester elastomer, or a thermoplastic styrene block copolymer. The sorbent particles 22 enmeshed in the web 20 may include activated carbon, activated alumina, zeolite, silica, catalyst supports, and the like. Any types of particles used in filter bed layers 12 may also be used in the non-woven web 20. The mesh size for sorbent particles 22 can be about 40×140. The mesh size for sorbent particles 22 may, in some cases, impact the pleating process and the weight of the particles 22 within the web 20. For example, pleated materials containing smaller particles 22 may have a more uniform particle distribution. Taking these factors into consideration, the web 20, for example, may include sorbent particles 22 with a mesh size including about 20×40 to about 100×140.

The web 20 may be co-pleated with the particulate filtering medium 16. The pleats in pleated web 20 may have a generally U-shaped appearance. Taller pleats provide more surface area and also result in a lower pressure drop. For example, pleats may be about 15 mm high, or taller or shorter. The distance between peaks of the pleats may range from about 3 mm to about 8 mm, or more or less. The distance between pleat peaks is often dependent upon the thickness of the web 20. The pleats may be generated using any suitable system, such as those known in the art, including knife blade style pleaters and a pusher bar style pleaters, resulting in what can generally be described as a U shaped pleat profile. Co-pleating as referred to herein may involve introducing the layers to be pleated individually into the pleating machine. The layers are fed from multiple rolls mounted on a suitable unwind stand.

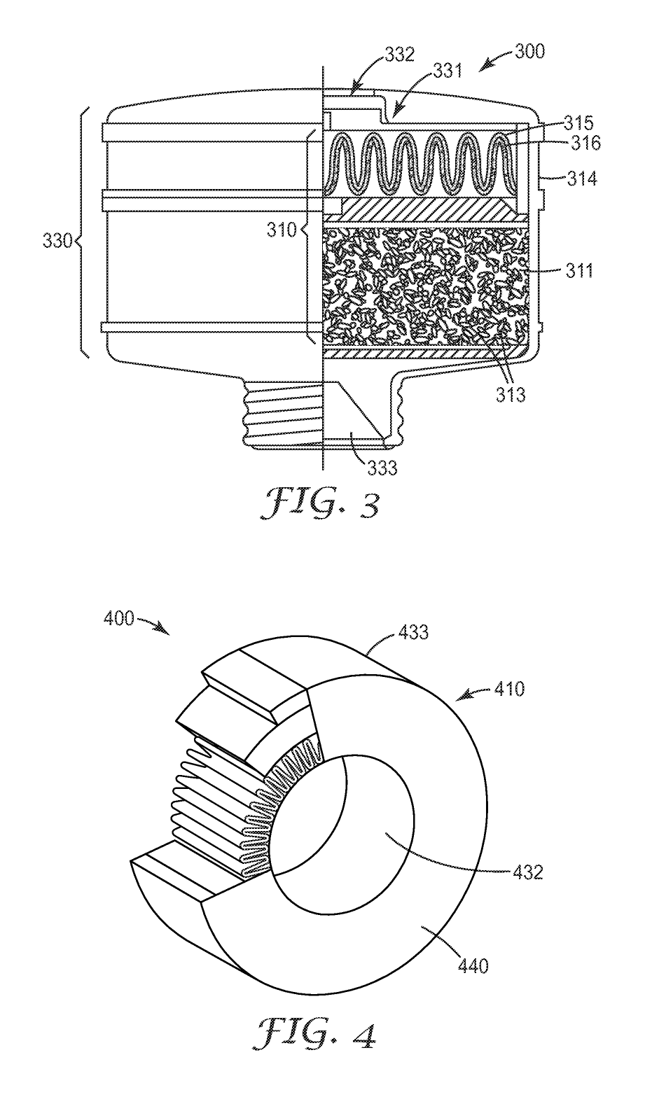

FIG. 3 shows a cut-away diagram of an exemplary filter assembly 300 including a filter system 310 disposed in a housing 330. The filter system 310 is disposed in an interior 331 of the housing 330. The housing 330 has a fluid inlet 322 that is in fluid communication with the fluid outlet 333. Fluid (such as a gas) may be forced or it may naturally flow into the fluid inlet 332. From there it passes through each of the filter elements sequentially, typically beginning with the one disposed nearest the fluid inlet 332. The filtered fluid then finally passes through the fluid outlet 333. In one embodiment, the flow of fluid passes through the pleated filter element 314 prior to passing through the filter bed 311. In an alternate embodiment, the fluid passes through the filter bed 311 prior to passing through the pleated filter element 314. Thus, the pleated filter element 314 may be disposed upstream or downstream of the filter bed 311. The filter assembly 300 is illustrated as having a generally planar configuration, and the housing 300 may be configured to have a generally planar configuration. However, filter assemblies according to other embodiments of the present disclosure may have any other suitable configurations, such as non-planar configurations.

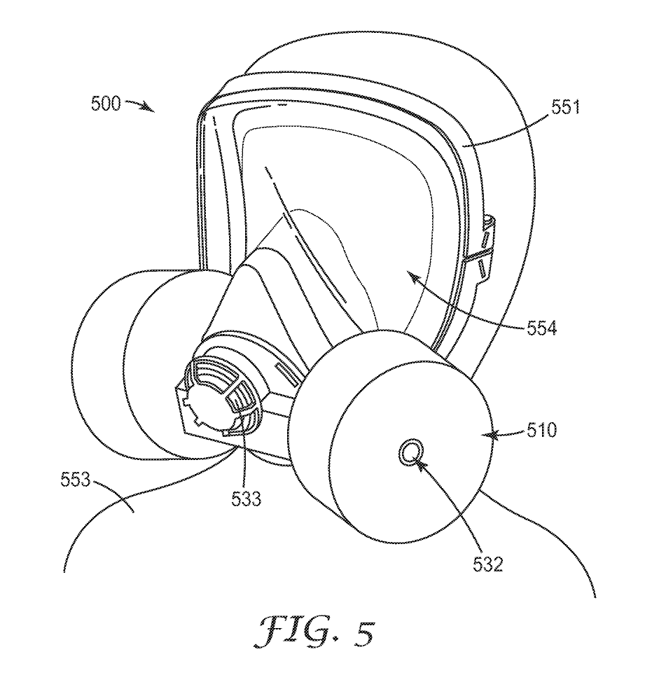

FIG. 4 shows an exemplary embodiment of a filter assembly 400 having a non-planar configuration. Here, the configuration of the filter assembly 400 is generally cylindrical. The filter system 410 is disposed in a housing 440, which may have a generally cylindrical shape. In this illustrated embodiment, the filter inlet 432 is disposed in the inner ring of generally cylindrical concentric filter elements and the filter outlet 433 is disposed at the periphery of the generally cylindrical configuration 400. In an alternate embodiment, the filter outlet 433 is disposed in the inner ring of concentric filter elements and the filter inlet 432 is disposed at the periphery of the cylindrical and concentric filter elements. Fluid is pumped, blown, or naturally flows into the filter assembly 400 through the filter inlet 432. It then passes through each filter element consecutively, beginning with the filter element located nearest to the inlet 432 and ending with the filter section located nearest to the outlet 432 before exiting through the outlet 432.

FIG. 5 illustrates an exemplary respiratory protection device 500, in which exemplary filter assemblies according to the present disclosure may be incorporated. The respiratory protection device has a face piece 551 enclosing at least the nose and mouth of the user 553. The face piece 551 has an interior portion 554. The respiratory protection device 550 has a fluid (e.g., air) intake path passing through an inlet 532 and a filter assembly 510 for supplying air to the interior portion 554 of the face piece 551. The filtered air is thereby made available for the user 553. Exhaled air may be forced out of the interior portion 554 of the face piece 551 through the outlet 533. The inlet 532 and outlet 533 are usually in fluid communication with each other. The respiratory protection device 500 could be a full face or hooded escape respirator, or a mask covering approximately half of the user's face. Alternatively, a filter system consistent with the present disclosure could also be used on a powered air purifying respirator including a blower which provides airflow to an individual user, or in collective protection systems such as those in building, tanks, tents, and ships.

### EXAMPLES

Two styles of sample filter were assembled in 4.15 inch diameter cylindrical cartridge bodies. The cartridge bodies were filled with granular sorbent material. In one example, a single layer of granular activated carbon material, URC treated with TEDA, was applied, using a storm-filling process to provide optimal packing density. Following the filling process a compressive load of approximately 30 to 35 pounds per square inch was applied to the layered sorbent structure, transmitted through a plate placed on top of the sorbent structure. The plate had holes to permit air passage. This plate was in turn ultrasonically staked at eight positions to the filter body to maintain the compressive load within the finished assembly. In a second example, two sequential layers of granular activated carbon material, URC treated with TEDA and catalyst containing nano sized gold particles, were assembled in a 4.15 inch diameter cylindrical cartridge body using the same procedure described above for example one.

Chemical filtering medium containing ZnCl₂-treated carbon was co-pleated with the particulate filtering medium using a knife blade pleater manufactured by Rabofsky GmbH. The particulate medium was a charged web with fluorochemical treatment. In a first sample filter, the chemical filtering medium included a non-woven web of polymeric fibers with approximately 600 gram per square meter of carbon particles treated with zinc chloride (ZnCl₂) enmeshed in the web. The web was formed by a melt-blowing process as described by United States Published Application No. 2006/0096911. In a second sample filter, the chemical filtering medium included a non-woven web of polymeric fibers as described above and contained activated carbon URC. The pleated elements were then added to the carbon beds and sealed in place with a polyurethane adhesive applied through a centrifugal spin-casting process.

Toxic gas (NH₃ or SO₂) was taken from a compressed gas cylinder of known concentration and mixed with make-up air that has been conditioned to the appropriate relative humidity (RH). The concentration, RH and flow of this combined challenge stream was measured, documented and controlled to a constant value for the duration of the test. Once the above characteristics were confirmed, the challenge stream was applied to the sample within a test chamber. The concentration of the toxic gas was monitored down stream of the test sample by an appropriate detector. When a specified breakthrough concentration was reached downstream of the test sample, the time was noted and the toxic gas flow was turned off. The sample box was then flushed with clean air for a known period of time. Following flushing of the test box, the spent test sample was removed from the test box and disposed of as toxic waste.

The exact conditions used for testing depend upon the desired level of protection of the final filter and the standard to which it will be approved, if such an approval is desired. Examples of test condition of the NIOSH specification for both an operational and an escape style filter are show in Table 1 below.

| | | Challenge | Relative | Breakthrough | Challenge |
|---|---|---|---|---|---|
| Standard | Challenge | Concentration | Humidity | Concentration | Flow |
| Reference | Gas | (ppm) | (%) | (ppm) | (LPM) |
| 42 CFR Part 84 | SO₂ | 750 | 25 | 5 | 64 |
| Attachment A: | SO₂ | 750 | 80 | 5 | 64 |
| Chemical | NH₃ | 1250 | 25 | 25 | 64 |
| Biological, | NH₃ | 1250 | 80 | 25 | 64 |
| radiological, | | | | | |
| nuclear air | | | | | |
| purifying escape | | | | | |
| respirator | | | | | |
| (NIOSH - APER) | | | | | |
| 42 CFR Part 84 | SO₂ | 1500 | 25 | 5 | 64 |
| Attachment A: | SO₂ | 1500 | 80 | 5 | 64 |
| Chemical | NH₃ | 2500 | 25 | 12.5 | 64 |
| Biological, | NH₃ | 2500 | 80 | 12.5 | 64 |
| radiological, | | | | | |
| nuclear full | | | | | |
| facepiece air | | | | | |
| purifying | | | | | |
| respirator | | | | | |
| (NIOSH - APR) | | | | | |

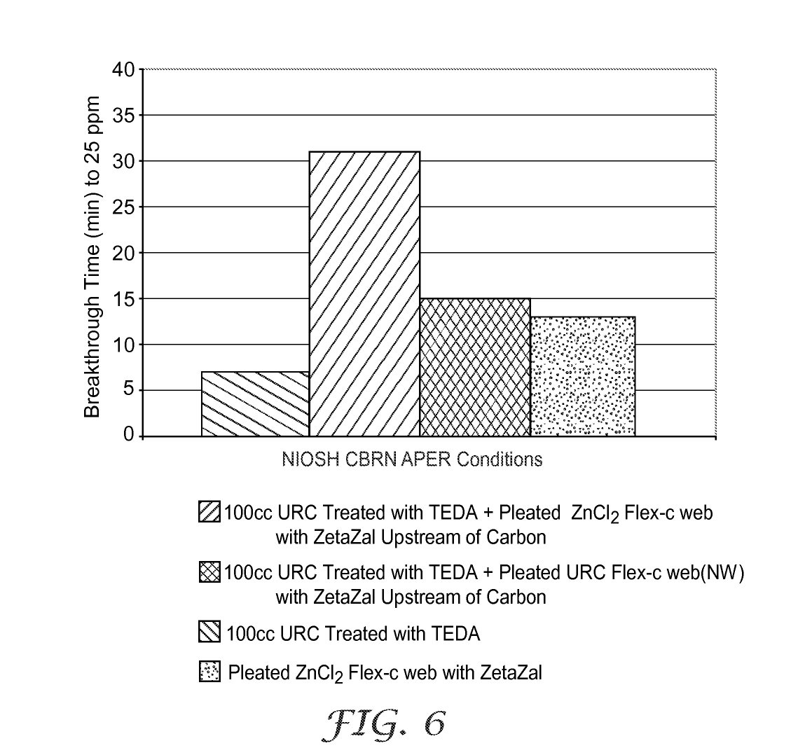

Both types of filters were tested for their ability to filter ammonia (NH₃) because NH₃ often drives the need for increased carbon volume in respirators when compared to the other nine gases that a respiratory filter is required to remove in order to meet NIOSH chemical, biological, radiological and nuclear (CBRN) respirator standards. The filters were tested according to APER test conditions, which are applied to filters intended for escape and evacuation applications. The breakthrough times and pressure drops measured for each of the two filters at 85 LPM are shown in FIG. 6.

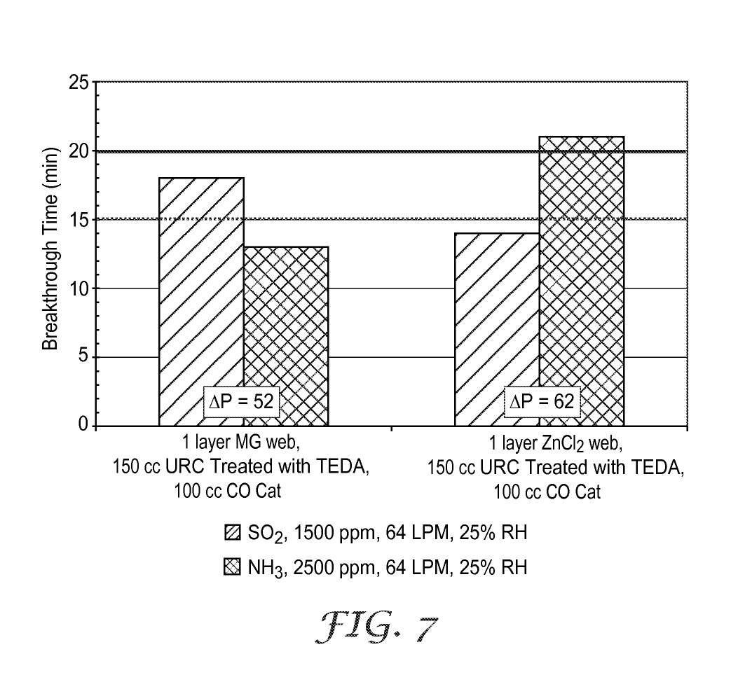

The two filters were tested a second time according to the more strenuous APR test conditions designed for filters used in hazardous work and entry environments. The breakthrough times and pressure drops measured for each of these two filters at 85 LPM are shown in FIG. 7. Both filters demonstrated excellent performance under described testing conditions. Specifically, the combination of a filter bed containing URC treated with TEDA with a pleated filter element containing ZnCl₂ treated carbon resulted in a 30 minute breakthrough time while the individual filter elements had breakthrough times of only 7 and 13 minutes, respectively, as shown in FIG. 6.

Although the present disclosure has been described with reference to preferred embodiments, those of skill in the art will recognize that changes made be made in form and detail without departing from the spirit and scope of the present disclosure.

1. A filter assembly comprising:
a filter bed comprising at least one chemical filtering medium, and
a pleated filter element comprising a particulate filtering medium and at least one chemical filtering medium,
wherein at least one chemical filtering medium of the pleated filter element and at least one chemical filtering medium of the filter bed are capable of targeting different chemical substances.

2. The filter assembly of claim 1, wherein the filter bed comprises granular sorbent material.

3. The filter assembly of claim 1, wherein the filter bed comprises a plurality of layers.

4. The filter assembly of claim 1, wherein at least one of the filter bed and the pleated filter element comprises at least one of: a sorbent, a catalyst, a chemically reactive medium and any combination thereof.

5. The filter assembly of claim 1, wherein at least one of the filter bed and the pleated filter element comprises at least one of: activated carbon, alumina, zeolite, silica, catalysts, catalyst supports and any combination thereof.

6. The filter assembly of claim 1, wherein at least one of the filter bed and the pleated filter element comprises multigas sorbent particles.

7. The filter assembly of claim 1, wherein the pleated filter element comprises at least one layer of particulate filtering medium and at least one layer of chemical filtering medium.

8. The filter assembly of claim 7, wherein at least one layer of the particulate filtering medium is detached from at least one layer of the chemical filtering medium and said layers are held together with netting.

9. The filter assembly of claim 1, wherein at least one chemical filtering medium of the filter bed comprises granular carbon; and
wherein the pleated filter element comprises at least one layer of a charged web and at least one layer of a nonwoven web populated with carbon particles treated with zinc chloride.

10. A filter assembly comprising:
a substantially fluid-impermeable housing having an interior, an inlet and an outlet in fluid communication with the inlet,
a filter bed comprising a chemical filtering medium disposed within the interior of the housing, and
a pleated filter element, disposed within the interior of the housing, comprising a particulate filtering medium and a chemical filtering medium.

11. The filter assembly of claim 10, wherein at least one chemical filtering medium of the pleated filter element and at least one chemical filtering medium of the filter bed are capable of targeting different chemical substances.

12. The filter assembly of claim 10, wherein the filter bed comprises a plurality of layers.

13. The filter assembly of claim 10, wherein at least one of the filter bed and the pleated filter element comprises at least one of: a sorbent, a catalyst, a chemically reactive medium and any combination thereof.

14. The filter assembly of claim 10, wherein at least one of the filter bed and the pleated filter element comprises at least one of: activated carbon, alumina, zeolite, silica, catalysts, catalyst supports and any combination thereof.

15. The filter assembly of claim 10, wherein the pleated filter element comprises at least one layer of particulate filtering medium and at least one layer of chemical filtering medium.

16. A filter assembly comprising:
a filter bed comprising a chemical filtering medium, and
a pleated filter element,
wherein the pleated filter element comprises a non-woven web of polymeric fibers and more than 60 percent weight sorbent particles enmeshed in the web.

17. The filter assembly of claim 16, wherein the sorbent particles in the filter bed and the sorbent particles enmeshed in the web possess filtration properties capable of targeting different chemical substances.

18. The filter assembly of claim 16, wherein the fibers comprise at least one of: a thermoplastic polyurethane elastomer, a thermoplastic polybutylene elastomer, a thermoplastic polyester elastomer, and a thermoplastic styrenic block copolymer, or any combination thereof.

19. The filter assembly of claim 16, wherein the sorbent particles comprise at least one of activated carbon, alumina, activated carbon, alumina, zeolite, silica, catalysts, catalyst supports or any combination thereof.

20. A respiratory protection device comprising a face piece that generally encloses at least the nose and mouth of a wearer, the face piece having an interior portion, the filter assembly of claim 1, connected to the face piece, and an air intake path for supplying air to the interior portion wherein the path passes through the filter assembly of claim 1.

21-23. (canceled)
